(19) United States
(12) Patent Application Publication
(10) Pub. No.: US 2008/0174058 A1
(43) Pub. Date: Jul. 24, 2008

(54) Fluid filled type engine mount

(75) Inventors: Akio Saiki, Komaki-shi (JP); Takayoshi Yasuda, Iwakura-shi (JP); Yuichi Ogawa, Kasugai-shi (JP)

Correspondence Address: OLIFF & BERRIDGE, PLC, P.O. BOX 320850, ALEXANDRIA, VA, 22320-4850, US

(73) Assignee: TOKAI RUBBER INDUSTRIES, LTD., KOMAKI-SHI (JP)

(21) Appl. No.: 12/010,060

(22) Filed: Jan. 18, 2008

(30) Foreign Application Priority Data
Jan. 22, 2007 (JP) 2007-011253

(51) Int. Cl. F16F 13/00

(52) U.S. Cl. 267/140.14

(57) ABSTRACT

A fluid filled type engine mount that includes a movable film that is disposed in a partition member so that a second orifice passage connects a pressure receiving chamber and an equilibrium chamber via the movable film. It also includes a valve member that is composed of: a valve body formed of ferromagnetic material; an urging member for exerting urging force on the valve body so that the second orifice passage is placed in a cutoff state by the valve body when the urging member is in an initial state; and a coil disposed in an interior of the partition member. The coil is energized to generate a magnetic field by which the valve body is displaced in order to place the second orifice passage in a communicating state.

### INCORPORATED BY REFERENCE

The disclosure of Japanese Patent Application No. 2007-011253 filed on Jan. 22, 2007 including the specification, drawings and abstract is incorporated herein by reference in its entirety.

### BACKGROUND OF THE INVENTION

1. Field of the Invention

The present invention relates to an engine mount for vibration-damped support of a power unit on a vehicle body, and relates in particular to a fluid filled type engine mount that exhibits effective vibration damping action on the basis of the flow behavior of a fluid sealed in the interior.

2. Description of the Related Art

One kind of fluid filled type engine mount known in the past as engine mount for an automobile or the like has a structure wherein a first mounting member and a second mounting member mounted respectively on the power unit and vehicle body are linked to one another by a main rubber elastic body, the mounting having formed therein a pressure receiving chamber a portion of whose wall is constituted by the main rubber elastic body, and an equilibrium chamber a portion of whose wall is constituted by a readily deforming, flexible film, with the pressure receiving chamber and the equilibrium chamber having a non-compressible fluid sealed therein, and with the two chambers connected to one another by an orifice passage. Sealed fluid type engine mounts of this kind exhibit outstanding vibration damping action through utilization of the flow behavior, such as the resonance behavior, of fluid induced to flow through the orifice passage.

Since vibration of different frequencies will be input depending on driving conditions and the like, it is preferable for an engine mount to be able to exhibit effective vibration damping action against vibration at a number of different frequencies. However, a problem is that frequencies damped effectively on the basis of the flow behavior of fluid induced to flow through the orifice passage is limited to a relatively narrow frequency band to which the orifice passage has been tuned in advance.

To address this problem there has been proposed, for example in U.S. Pat. No. 4,610,421, a fluid filled type engine mount of electromagnetically switched type, provided with a first orifice passage that is tuned to a low-frequency band corresponding to engine shake, and a second orifice passage that is tuned to a medium- to high-frequency band corresponding to idling vibration or the like, and designed to be switched between the first and second orifice passages by a valve body actuated and displaced through the action of a magnetic field generated by energizing a coil. With this engine mount, by controlling energizing of the coil according to driving conditions and so on, it is possible to achieve effective vibration damping action against both engine shake which poses a problem during driving, and idling vibration which poses a problem when the vehicle is at a stop.

However, research conducted by the inventors has shown that the engine mount taught in U.S. Pat. No. 4,610,421 still has room for improvement.

Specifically, the engine mount disclosed in U.S. Pat. No. 4,610,421 is designed so that when the second orifice passage is to be blocked off during driving, the coil is energized by an external power supply; and when the second orifice passage is to be opened up with the vehicle at a stop, energizing of the coil is suspended, whereupon the second orifice passage is placed in the communicating state by the urging force of urging member such as a coil spring.

With this kind of energization control, since it is necessary to energize the coil for the longer periods for which it is used during driving, the duration of energization of the coil will be prolonged and power consumption becomes considerable. Problems such as heat emission or poor mileage can result.

Furthermore, recent higher requirements with regard to ride comfort and quiet have created a need for an engine mount affording outstanding vibration damping action against wider range of frequencies and more frequency bands, while still employing a simple structure. It is also necessary for effective vibration damping to be achieved in even in instances where frequencies of several frequency bands interact; for example, with regard to idling vibration produced when the vehicle is at a stop, low-frequency vibration has come to be seen as a problem, in addition to the medium- and high-frequency vibration considered as problems in the past.

Moreover, with fluid filled type vibration damping devices having fluid sealed in the interior and designed so that actuating force for the valve body is provided by energizing a coil, it was necessary to mount the coil on the exterior of the vibration damping device in order to avoid problems such as electrical leakage during energization of the coil. For this reason, a fluid filled type vibration damping of sufficiently compact size had yet to be achieved.

### SUMMARY OF THE INVENTION

It is therefore one object of this invention to provide a fluid filled type engine mount of novel structure, capable of affording effective vibration damping action against a wide range of frequencies, with low power consumption.

The above and/or optional objects of this invention may be attained according to at least one of the following modes of the invention. The following features and/or elements employed in each mode of the invention may be adopted at any possible optional combinations. It is to be understood that the principle of the invention is not limited to these modes of the invention and combinations of the technical features, but may otherwise be recognized based on the teachings of the present invention disclosed in the entire specification and drawings or that may be recognized by those skilled in the art in the light of the present disclosure in its entirety.

One aspect of the present invention provides a fluid filled type engine mount comprising: a first mounting member fixable to one of a power unit and a vehicle body; a second mounting member mounted on another of the power unit and the vehicle body; a main rubber elastic body elastically connecting the first mounting member and the second mounting member; a partition member supported by the second mounting member; a pressure receiving chamber whose wall is partially constituted by the main rubber elastic body and having a non-compressible fluid filled therein; an equilibrium chamber whose wall is partially constituted by a readily deforming, flexible film and having the non-compressible fluid filled therein, the chambers being formed respectively to either side of the partition member; a first orifice passage and a second orifice passage respectively connecting the pressure receiving chamber and the equilibrium chamber to each other, with the second orifice passage being tuned to a frequency band corresponding to idling vibration which is a higher frequency band than the first orifice passage; and a valve member actuated by energization from an outside so that the second orifice passage is switchable between a communicating state and a cutoff state by the valve member; wherein a movable film is disposed in the partition member so that the second orifice passage connects the pressure receiving chamber and the equilibrium chamber via the movable film; wherein the valve member includes: a valve body formed of ferromagnetic material; an urging member for exerting urging force on the valve body so that the second orifice passage is placed in the cutoff state by the valve body when the urging member is in an initial state; and a coil disposed in an interior of the partition member, and wherein the coil is energized to generate a magnetic field by which the valve body is displaced in order to place the second orifice passage in the communicating state.

In the fluid filled type engine mount constructed according to the present invention, the second orifice passage is tuned to a frequency band corresponding to idling vibration which tends to be problem when the vehicle is at a stop. While the vehicle is being driven the second orifice passage is blocked off without energizing the coil, by utilizing the urging force of the urging member, whereby sufficient flow of fluid through the first orifice passage can be assured and effective vibration damping action can be achieved against low-frequency band vibration such as engine shake. On the other hand, with the vehicle at a stop, the second orifice passage is opened up by energizing the coil, whereby effective vibration damping action against vibration corresponding to medium- to high-frequency band idling vibration can be achieved on the basis of the flow behavior of fluid induced to flow through the second orifice passage. Since the coil is thereby energized for only relatively brief periods of service, the power consumption entailed in energizing the coil can be reduced. Accordingly, it is possible to advantageously achieve improved mileage, to prevent heat emission, and so on.

Moreover, since the second orifice passage is designed to connect the pressure receiving chamber and the equilibrium chamber via the movable film, the spring hardness of the wall of pressure receiving chamber wall can be varied between the communicating state and the cutoff state of the second orifice passage. By so doing, with the second orifice passage in the communicating state, the tuning frequency of the first orifice passage will change to a lower frequency than the tuning frequency of the first orifice passage with the second orifice passage in the cutoff state. Consequently, when the vehicle is at a stop causing the second orifice passage to open, the first orifice passage will become tuned to a frequency band that corresponds to low-frequency idling vibration, which vibration has a lower frequency band than engine shake; and effective vibration damping action against this vibration will be produced on the basis of flow behavior of the fluid induced to flow through the first orifice passage. Thus, a high degree of vibration damping action against input vibration with the vehicle at a stop can be obtained.

Additionally, by installing the coil in the interior of the partition member, contact of the coil with the non-compressible fluid sealed within the pressure receiving chamber or the equilibrium chamber can be advantageously avoided. Consequently, problems such as current leakage during energization can be prevented and stable operation can be achieved, while at the same time affording an electromagnetically switched fluid filled type engine mount which is a compact unit.

In the fluid filled type engine mount pertaining to the present invention, the partition member is furnished with a valve housing zone situated on a fluid passage passing through the second orifice passage and having the valve body disposed housed therein; with the urging member in the initial state, a communication hole used for fluid flow which opens into the valve housing zone is blocked off by the valve body thereby placing the second orifice passage in the cutoff state; and by energizing the coil the valve body is moved apart from a wall of the valve housing zone thereby opening the communication hole and placing the second orifice passage in the communicating state.

Where such a structure is employed, it will be possible with a simple structure to easily realize valve member for switching the second orifice passage between the communicating state and the cutoff state. The initial state of the urging member herein refers to a state in which the urging member has not undergone any deformation etc. from its as-installed condition due to a load or other external force input to the urging member; where, for example, the urging member has been disposed in a pre-compressed state, it will refer to a state in which no additional load is input to the urging member in its pre-compressed state.

In the fluid filled type engine mount pertaining to the present invention, where a structure like that described above is employed, there may be favorably employed a structure wherein a plate-shaped portion is provided to the valve body, and a communication window is formed in the plate-shaped portion at a location that, with the valve body disposed housed within the valve housing zone, is situated away from the formation location of the communication hole; with the urging member in the initial state, the plate-shaped portion is juxtaposed against the wall of the valve housing zone where the communication hole is formed, blocking off the communication hole and the communication window and thereby placing the second orifice passage in the cutoff state; and by energizing the coil the plate-shaped portion is displaced through magnetic attraction moving the plate-shaped portion away from the wall of the valve housing zone so as to open up the communication hole and the communication window, thereby placing the second orifice passage in the communicating state.

In a fluid filled type engine mount of structure such as that described above, there will preferably be employed a structure in which the communication hole and the communication window are disposed at mutually different locations in the diametrical direction. If this is done, there will be no need to relatively position the valve body and the valve housing zone on the circumferential direction when installing the valve body in the valve housing zone, making it possible to easily switch the communication hole and the communication window between the blocked off state and the communicating state, and simplifying the valve body assembly procedure.

In the fluid filled type engine mount pertaining to the present invention, there can be employed a structure wherein a coil spring is employed as the urging member, with the coil spring interposed between the valve body and the partition member.

Through the elastic force of the coil spring, urging force can be provided easily and inexpensively thereby.

The fluid filled type engine mount pertaining to the present invention may be designed so that the valve body will undergo displacement in opposition to the urging force of the urging member, due to a high level of negative pressure produced in the pressure receiving chamber, to thereby place the second orifice passage in the communicating state.

Noise and vibration which occur due to cavitation can be alleviated or avoided thereby. Specifically, noise and vibration produced by cavitation is thought to occur where a high level of negative pressure produced in the pressure receiving chamber by input of a large impact load etc., has caused dissolved gases present in the sealed non-compressible fluid to separate out as bubbles, with noise and vibration being produced by shock waves (water hammer pressure) produced when the bubbles disappear. Accordingly, by designing the second orifice passage to open in the event that pressure in the pressure receiving chamber has fallen below a preset numerical value, negative pressure in the pressure receiving chamber can be dissipated rapidly, and the occurrence of noise and vibration can be alleviated or avoided.

In the present invention, during driving, when noise and vibration being produced by cavitation becomes a problem, the coil is unenergized, and the valve body cuts off the second orifice passage due to the urging force of the urging member. Consequently, a mechanical design whereby the valve body will open at a set negative pressure can be realized through proper adjustment of the urging force of the urging member.

### BRIEF DESCRIPTION OF THE DRAWINGS

The foregoing and/or other objects features and advantages of the invention will become more apparent from the following description of a preferred embodiment with reference to the accompanying drawings in which like reference numerals designate like elements and wherein:

FIG. 1 is a vertical cross sectional view of a fluid filled type automotive engine mount according to a first embodiment of the present invention, wherein it is in a non-energized state;

FIG. 2 is a vertical cross sectional view of the fluid filled type automotive engine mount of FIG. 1, wherein it is in an energized state;

FIG. 3 is a graph demonstrating vibration-damping characteristics of the engine mount of FIG. 1, i.e., in the non-energized state;

FIG. 4 is a graph demonstrating vibration-damping characteristics of the engine mount of FIG. 2, i.e., in the energized state; and

FIG. 5 is a vertical cross sectional view of a fluid filled type automotive engine mount according to a second embodiment of the present invention.

### DETAILED DESCRIPTION OF PREFERRED EMBODIMENTS

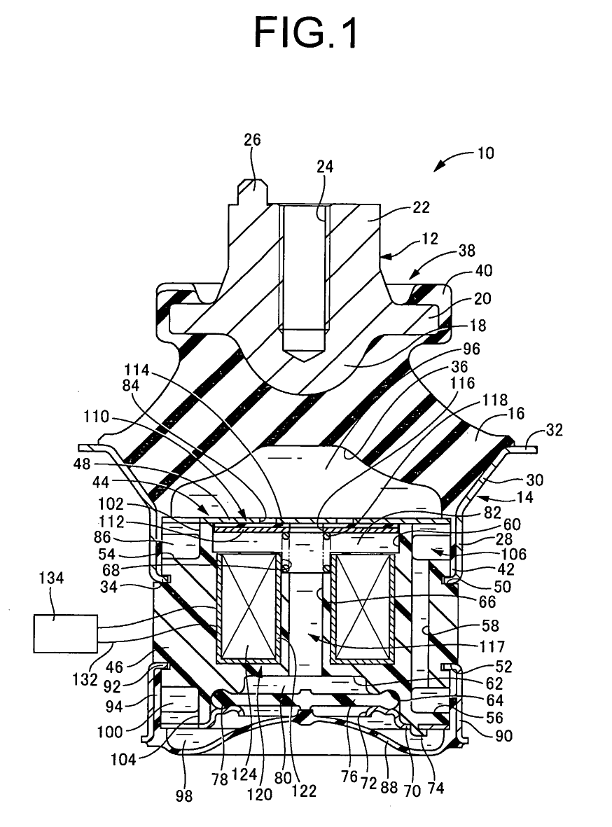

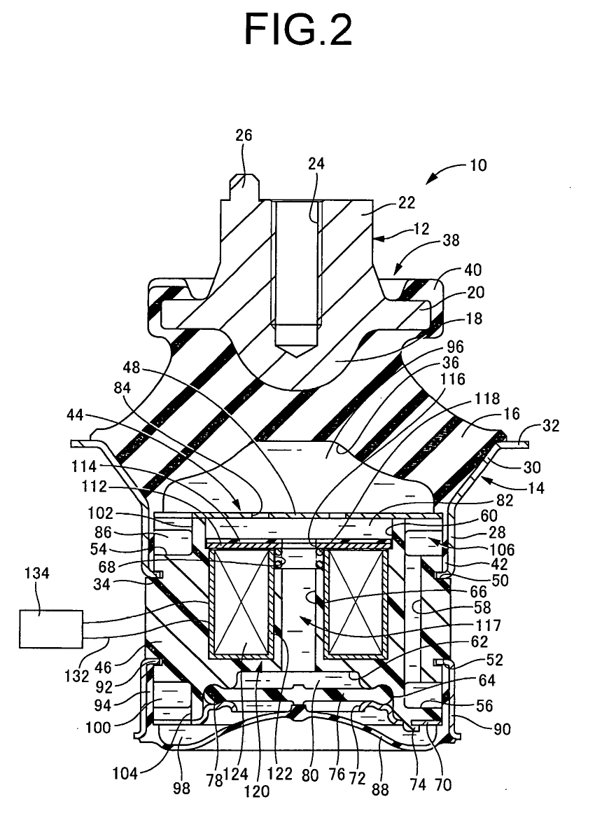

Referring first to FIGS. 1 and 2, there is shown an automotive engine mount 10 by way of a first embodiment of the present invention. This engine mount 10 has a structure wherein a first mounting member 12, and a second mounting member 14, are linked by a main rubber elastic body 16. The first mounting member 12 is attached to the power unit of the automobile (not shown) and the second mounting member 14 is attached to the body of the automobile (not shown). The power unit is thereby resiliently supported on the vehicle body via the engine mount 10. In the description hereinbelow, unless indicated otherwise, the vertical direction refers to the vertical direction in FIG. 1, which represents the principal load input direction.

To describe in more detail, the first mounting member 12 is a rigid member fabricated of iron, aluminum alloy or the like having a generally circular block shape overall. The first mounting member 12 is also provided with a fastener portion 18 of generally semispherical shape downwardly convex in the axial direction. Furthermore, a stopper portion 20 is integrally formed on the upper end of the fastener portion 18 and extends outwardly in the axis-perpendicular direction about the entire circumference. Also, a thread portion 22 of generally circular post shape is integrally formed extending in the axial direction above the stopper portion 20. In the thread portion 22 there is formed a bolt hole 24 extending along the center axis; a fastening bolt (not shown) is threaded into the bolt hole 24 in order to fixedly mount the first mounting member 12 onto a member on the power unit side (not shown). In the present embodiment, a positioning projection 26 that projects axially upward from the diametrical center portion at one location along the circumference is integrally formed at the upper end of the thread portion 22.

The second mounting member 14 has a thin-walled, large-diameter, generally circular cylinder shape overall, and is formed by a rigid member of iron, aluminum alloy, or similar material. The second mounting member 14 in the portion thereof below its axial medial section is constituted as a cylindrical section 28 that projects in the axial direction with generally unchanging diameter; and in the portion above the axial medial section is constituted as a tapered section 30 that flares out gradually going upward in the axial direction. Furthermore, a flange portion 32 that extends outwardly in the axis-perpendicular direction is integrally formed at the upper end of the tapered section 30. Also, at the axial lower end of the second mounting member 14 there is formed a first mating projection 34 of annular shape projecting inwardly in the diametric direction and extending continuously about the entire circumference. A bracket (not shown) is fastened externally to the second mounting member 14, for example. The second mounting member 14 is fixedly mounted to the vehicle body side by fixedly mounting the bracket onto a component on the vehicle body side (not shown).

The first mounting member 12 and the second mounting member 14 are disposed coaxially with one another, and with the first mounting member 12 positioned axially above and spaced apart from the upper opening of the second mounting member 14. The main rubber elastic body 16 is interposed between the first mounting member 12 and the second mounting member 14. The main rubber elastic body 16 is a thick rubber elastic body of generally frustoconical shape overall, having formed in the center portion of its lower end a circular recess 36 that opens downward in the axial direction.

The fastener portion 18 of the first mounting member 12 is vulcanization bonded so as to be embedded in the axial upper end of the main rubber elastic body 16, and the stopper portion 20 is vulcanization bonded with its diametrical center portion juxtaposed against the upper end face of the main rubber elastic body 16 from above in the axial direction, thereby vulcanization bonding the first mounting member 12 to the center portion in the axis-perpendicular direction of the main rubber elastic body 16. Meanwhile, the second mounting member 14 is vulcanization bonded with its tapered section 30 juxtaposed against the outside peripheral face of the axial lower end of the main rubber elastic body 16, thereby vulcanization bonding the second mounting member 14 to the axis-perpendicular outside peripheral face of the main rubber elastic body 16. In this way, in the present embodiment the main rubber elastic body 16 is formed as an integrally vulcanization molded part 38 integrally furnished with the first mounting member 12 and the second mounting member 14.

A stopper rubber 40 is integrally formed at the axial upper end of the main rubber elastic body 16. The stopper rubber 40 is formed covering generally the entire face of the outside peripheral section of the stopper portion 20 of the first mounting member 12. It projects a prescribed height axially upward beyond the upper face of the stopper portion 20.

A seal rubber layer 42 is integrally formed at the axial lower end of the main rubber elastic body 16. This seal rubber layer 42 is a thin rubber layer of generally circular cylinder shape formed extending axially downward from the outside peripheral wall of the circular recess 36, and vulcanization bonded to the second mounting member 14 so as to cover generally the entire inside peripheral face of its cylindrical section 28. The second mounting member 14 is thereby covered over the entire inside face of its tapered section 30 and its cylindrical section 28 by the main rubber elastic body 16 and by the seal rubber layer 42. The seal rubber layer 42 is thin in comparison with the peripheral edge of the lower end of the main rubber elastic body 16, and forms a shoulder at the boundary between the main rubber elastic body 16 and the seal rubber layer 42.

A partition member 44 is attached in the axial lower opening section of the second mounting member 14, and is supported by the second mounting member 14. The partition member 44 has a generally circular cylindrical shape overall; in the present embodiment, it is composed of a cap fitting 48 of thin disk shape juxtaposed against the upper end face of a partition member body 46. In preferred practice the partition member 44 will be formed of non-magnetized material.

The partition member body 46 is of generally circular block shape. In the present embodiment, it is formed of hard synthetic resin. On the partition member body 46 there are formed first and second mating grooves 50, 52 that open onto the outside peripheral face and extend continuously in the circumferential direction. The first mating groove 50 is spaced a prescribed distance above the second mating groove 52 in the axial direction.

At the upper end of the partition member body 46 is formed an upper circumferential slot 54 that opens onto the outside peripheral face and extends continuously for a prescribed length in the circumferential direction. At the lower end of the partition member body 46 is formed a lower circumferential slot 56 that opens onto the outside peripheral face and extends continuously for a prescribed length in the circumferential direction. In the present embodiment, the upper circumferential slot 54 is formed in a section of the partition member body 46 situated axially above the first mating groove 50, while the lower circumferential slot 56 is formed in a section of the partition member body 46 situated axially below the second mating groove 52.

The circumferential edges of the upper circumferential slot 54 and the lower circumferential slot 56 are aligned in position with one another in the circumferential direction, and are positioned so as to overlap when viewed in axial direction projection. A through-hole 58 is formed extending in a straight line in the axial direction between the mutually aligned upper circumferential slot 54 and lower circumferential slot 56, and passing in the axial direction between one of the circumferential edges of each. This through-hole 58 opens at one end thereof onto the lower face of the circumferential edge of the upper circumferential slot 54, and at the other end thereof onto the upper face of the circumferential edge of the lower circumferential slot 56, so that the upper and lower circumferential slots 54, 56 communicate with each other through the through-hole 58. The axial upper wall of the upper circumferential slot 54 is cut away at the location where the through-hole 58 is formed.

An upper recess 60 is formed on the upper end of the partition member body 46. The upper recess 60 is a shallow recess of generally unchanging circular cross section, and is formed so as to open axially upward in the generally center portion across the diameter of the partition member body 46. In the present embodiment, the upper recess 60 is formed spaced apart to the inside peripheral side of the upper circumferential slot 54.

A lower recess 62 is formed on the lower end of the partition member body 46. The lower recess 62 is a recess of generally circular shape in cross section, and is formed so as to open axially downward in the generally center portion across the diameter of the partition member body 46. Also, in the present embodiment, an annular shoulder portion 64 which extends in the diametric direction is formed at the rim of the opening of the lower recess 62. Thus, the lower recess 62 in the present embodiment has a stepped concave shape smaller in diameter in the section axially above the shoulder portion 64 than in the section axially below it. In the present embodiment, the large-diameter section and the small-diameter section of the lower recess 62 are each formed spaced apart to the inside peripheral side of the lower circumferential slot 56.

A through-passage hole 66 extends in the axial direction through the diametrical center section of the partition member body 46. This through-passage hole 66 is formed in a straight line extending along the center axis of the partition member body 46 and passes through it so as to open respectively onto the axial end faces of the partition member body 46. In the present embodiment, a large-diameter portion 68 is formed at the rim of the upper opening of the through-passage hole 66, with the upper end of the through-passage hole 66 being relatively large in diameter. Also, in the present embodiment, one opening of the through-passage hole 66 opens into the center of the floor of the upper recess 60 while the other opening opens into the center of the floor of the lower recess 62, so that the upper recess 60 and the lower recess 62 communicate with each other through the through-passage hole 66.

A holding fitting 70 is attached to the lower face of the partition member body 46. The holding fitting 70 is a high-rigidity fitting formed by press molding of thin sheet steel or the like, and has a shape resembling an inverted ashtray overall. The holding fitting 70 is disposed covering the opening of the lower recess 62 formed in the partition member body 46. Furthermore, a large-diameter center hole 72 is formed in the diametrical center section of the holding fitting 70, passing through the upper floor thereof in the axial direction, i.e. the thickness direction; through the center hole 72, the lower recess 62 communicates with a zone on the opposite side of the holding fitting 70 therefrom.

Engaging holes that extend for prescribed length in the circumferential direction are formed at multiple locations along the circumference of an annular plate-shaped section provided to the outside peripheral section of the holding fitting 70. The holding fitting 70 is attached to the partition member body 46 by inserting and locking within these engaging holes engaging hooks 74 which are provided on the lower end face of the outside peripheral section of the partition member body 46.

A movable rubber film 76 constituting the movable film is disposed between the axially opposed faces of the inside peripheral edge of the holding fitting 70 and the shoulder portion 64 provided to the partition member body 46. The movable rubber film 76 is formed of a rubber elastomer of generally disk shape, and has diameter sufficiently larger than the diameter of the opening of the lower recess 62 and the diameter of the center hole 72 of the holding fitting 70. At the outside peripheral edge of the movable rubber film 76 is formed an annular support portion 78 which extends continuously in the circumferential direction with generally unchanging circular cross section; the movable rubber film 76 is relatively thick at its outside peripheral edge where the support portion 78 is formed.

The movable rubber film 76 is disposed generally coaxially with the partition member body 46, and is attached to the partition member body 46 by being juxtaposed against the partition member body 46 from axially below, with its outside peripheral edge clamped between the partition member body 46 and the holding fitting 70. In the attached state, the outside peripheral edge of the movable rubber film 76 is supported clasped between the shoulder portion 64 and the holding fitting 70, while the diametrical center section of the movable rubber film 76 is positioned over the opening of the lower recess 62 of the partition member body 46 as well as positioned over the center hole 72 of the holding fitting 70, permitting slight displacement up and down in the axial direction through elastic deformation of the movable rubber film 76.

By positioning the movable rubber film 76 in this way so that the opening of the lower recess 62 is covered by the movable rubber film 76, utilizing lower recess 62 there is formed to the upper side of the movable rubber film 76 a middle chamber 80 a portion of whose wall is constituted by the movable rubber film 76.

The cap fitting 48 is juxtaposed against the upper face of the partition member body 46. The cap fitting 48 is thin and of generally disk shape; in the present embodiment it is a high-rigidity component fabricated of metal material. Also, in the present embodiment, the outside diameter of the cap fitting 48 is approximately equal to the outside diameter of the partition member body 46.

By juxtaposing the cap fitting 48 against the upper face of the partition member body 46 in this way, the opening of the upper recess 60 is closed off by the cap fitting 48. Thus, utilizing the upper recess 60, there is formed a valve housing zone 82. Passage holes 84 are formed by way of communication holes passing though the diametrical center section of the cap fitting 48. Several passage holes 84 are formed spaced apart by prescribed distance in the circumferential direction, and passing through the cap fitting 48 in the thickness direction. The valve housing zone 82 communicates through the passage holes 84 with a zone to the opposite side of the cap fitting 48 therefrom, and communicates with the middle chamber 80 through the through-passage hole 66.

In the present embodiment, the partition member 44 is constituted by attaching the cap fitting 48 to the partition member body 46 in this way. The partition member 44 is then secured fitting into the second mounting member 14. Specifically, the upper end section of the partition member 44 is inserted into the second mounting member 14 from axially below, and the second mounting member 14 is subjected to a diameter constricting process such as crimping from all sides to securely attach the partition member 44 to the second mounting member 14. Also, the first mating projection 34 provided on the axial lower end of the second mounting member 14 interlocks with the first mating groove 50 formed on the outside peripheral face of the partition member body 46, thereby securing the partition member 44 positioned in the axial direction with respect to the second mounting member 14.

Furthermore, in the present embodiment, a shoulder is formed in the boundary section between the lower end of the main rubber elastic body 16 and the seal rubber layer 42; and through contact of the outside peripheral edge of the upper end of the partition member 44 against the shoulder from below, the partition member 44 is positioned in the axial direction with respect to the second mounting member 14, and the cap fitting 48 is attached securely to the partition member body 46.

The outside peripheral face of the upper end of the partition member 44 is juxtaposed fluid-tightly, via the seal rubber layer 42, against the inside peripheral face of the cylindrical section 28 of the second mounting member 14. The opening of the upper circumferential slot 54 provided to the partition member 44 is thereby blocked off fluid-tightly by the cylindrical section 28 of the second mounting member 14, forming an upper passage 86 of tunnel form which extends a prescribed distance in the circumferential direction.

A diaphragm 88 serving as a flexible film is disposed below the partition member 44. The diaphragm 88 is formed of a thin rubber film having ample slack, and has a generally circular dome shape. A fastener fitting 90 is vulcanization bonded to the outside peripheral edge of the diaphragm 88. The fastener fitting 90 has a thin, generally circular cylinder shape, and its upper end portion constitutes a second mating projection 92 that projects diametrically inward. The outside peripheral edge of the diaphragm 88 is vulcanization bonded to the lower end of the fastener fitting 90, and a sheath rubber 94 integrally formed with the diaphragm 88 is vulcanization bonded over its entire face to the inside peripheral face of the fastener fitting 90. As will be understood from the preceding, the diaphragm 88 in the present embodiment is formed as an integrally molded part furnished with the fastener fitting 90.

The diaphragm 88 is securely attached to the partition member 44 with the fastener fitting 90 fitted externally on the lower end of the partition member 44, and the fastener fitting 90 subjected to subjected to a diameter constricting process such as crimping from all sides. Furthermore, the second mating projection 92 provided at the upper end of the fastener fitting 90 interlocks with the second mating, groove 52 provided on the outside peripheral face of the partition member 44, thereby securing the fastener fitting 90 positioned in the axial direction with respect to the partition member 44. As a result, the diaphragm 88 is disposed covering the axial lower side of the partition member 44.

In the present embodiment, the diameter constricting process of the second mounting member 14 and the diameter constricting process of the fastener fitting 90 are carried out simultaneously. Specifically, the integrally vulcanization molded part 38 of the main rubber elastic body 16, the partition member 44, and the integrally molded part of the diaphragm 88 are positioned with respect to one another by being set in a jig or the like; and a crimping process is carried out simultaneously on the second mounting member 14 in the integrally vulcanization molded part 38 of the main rubber elastic body 16 and on the fastener fitting 90 in the integrally molded part of the diaphragm 88, securing the integrally vulcanization molded part 38 of the main rubber elastic body 16 and the integrally molded part of the diaphragm 88 onto the partition member 44 in the same process.

By attaching the partition member 44 and the diaphragm 88 to the integrally vulcanization molded part 38 of the main rubber elastic body 16 in this way, a pressure receiving chamber 96 a portion of whose wall is constituted by the main rubber elastic body 16 and which has a non-compressible fluid sealed therein is formed in the axial direction between the main rubber elastic body 16 and the partition member 44 on the one hand; while an equilibrium chamber 98 a portion of whose wall is constituted by the diaphragm 88 and which has a non-compressible fluid sealed therein is formed in the axial direction between the partition member 44 and the diaphragm 88. The pressure receiving chamber 96 gives rise to pressure fluctuations when vibration is input; while the equilibrium chamber 98 allows changes in volume through elastic deformation of the diaphragm 88. In the present embodiment, the pressure receiving chamber 96 is formed by the opening of the circular recess 36 provided to the main rubber elastic body 16 being covered by the partition member 44, while the equilibrium chamber 98 is formed by the opening of the lower recess 62 provided to the partition member 44 being covered by the diaphragm 88.

Sealing of the non-compressible fluid within the pressure receiving chamber 96 and the equilibrium chamber 98 may be accomplished advantageously by carrying out assembly of the partition member 44 with the integrally vulcanization molded part 38 of the main rubber elastic body 16, and assembly of the partition member 44 with the diaphragm 88, while submerged in the non-compressible fluid, for example. The non-compressible fluid sealed in pressure receiving chamber 96 and the equilibrium chamber 98 is not limited to any particular fluids; water, alkylene glycols, polyalkylene glycols, silicone oil, mixtures of these, or the like may be used favorably. Furthermore, in order to advantageously achieve vibration damping action based on flow behavior of the fluid, discussed later, it is preferable to use a low-viscosity fluid having viscosity of 0.1 Pa·s or lower.

By juxtaposing the inside peripheral face of the fastener fitting 90 against the outside peripheral face of the lower end of the partition member 44 via the sheath rubber 94, the opening at the outside peripheral side of the lower circumferential slot 56 is covered fluid-tightly by the fastener fitting 90. A lower passage 100 that extends a prescribed length in the circumferential direction through the lower end portion of the partition member 44 is formed thereby.

As discussed above, the upper passage 86 and the lower passage 100 communicate with one another through the through-hole 58 thereby forming a tunnel-like passage extending in total a prescribed length equal to about once around in the circumferential direction.

Furthermore, one end of the tunnel-like passage communicates with the pressure receiving chamber 96 through a cutout portion 102 formed in the outside peripheral edge of the partition member body 46 and the cap fitting 48. The other end of the tunnel-like passage communicates with the equilibrium chamber 98 through a cutout portion 104 formed in the outside peripheral edge of the partition member body 46 and the holding fitting 70. A first orifice passage 106 which utilizes the upper passage 86, the lower passage 100, and the through-hole 58 to interconnect the pressure receiving chamber 96 and the equilibrium chamber 98 is formed thereby.

A valve member 110 is positioned housed within the valve housing zone 82 which is provided to the partition member 44. The valve member 110 has a disk shape overall, and includes a valve fitting 112 serving as the valve body, and a cushion rubber layer 114 affixed to the valve fitting 112. The valve member 110 is positioned on a line extended from the through-passage hole 66, and is disposed so as to spread out in axis-perpendicular direction within the valve housing zone 82.

The valve fitting 112 is a ferromagnetic body formed of magnetic material such as iron or silicon steel, having a thin, generally disk shape and outside diameter slightly smaller than the inside diameter of the valve housing zone 82. A communication window 116 of diameter approximately equal to that of the through-passage hole 66 passes in the thickness direction through the diametrical center section of the valve fitting 112. With the valve member 110 disposed in the valve housing zone 82, this communication window 116 will be situated at a location differing in the diametric direction from those of the passage holes 84 formed in the cap fitting 48. In the present embodiment, the communication window 116 is located in the diametrical center, with the plurality of passage holes 84 situated spaced apart to the outside peripheral side so as to encircle the communication window 116.

The cushion rubber layer 114 is affixed to the upper face of the valve fitting 112. The cushion rubber layer 114 has annular plate shape generally similar to the valve fitting 112, and is affixed to the upper face of the valve fitting 112 so as to cover it entirely.

Here, the pressure receiving chamber 96 and the middle chamber 80 communicate with one another through the passage holes 84, the communication window 116, the valve housing zone 82, and the through-passage hole 66. The wall of the middle chamber 80 on the equilibrium chamber 98 side thereof is constituted by the movable rubber film 76; the middle chamber 80 is substantially in communication with the equilibrium chamber 98 through transmission of liquid pressure by elastic deformation of the movable rubber film 76. Thus, in the present embodiment, a second orifice passage 117 connecting the pressure receiving chamber 96 and the equilibrium chamber 98 to each other is constituted by the passage holes 84, the communication window 116, the valve housing zone 82, and the through-passage hole 66.

In the present embodiment, the total cross sectional area of the passage holes 84, the cross sectional area of the communication window 116, and the cross sectional area of the through-passage hole 66 are approximately identical to one other. In the present embodiment, by appropriately setting the ratio of cross sectional area of the passage holes 84, the communication window 116, and the through-passage hole 66 to the passage length of the second orifice passage 117, the tuning frequency of the second orifice passage 117 is tuned to a higher frequency band than the tuning frequency of the first orifice passage 106.

A coil spring 118 serving as an urging member is disposed in the axial direction between the partition member body 46 and the valve member 110. The coil spring 118 is disposed concentrically with the valve member 110, positioned with its lower end fitting into the large-diameter portion 68 provided at the upper end of the through-passage hole 66.

The valve member 110 is urged axially upward by the coil spring 118 arranged in the above manner, and is pushed against the cap fitting 48 from below in the axial direction. Since the passage holes 84 formed in the cap fitting 48 and the communication window 116 formed in the valve member 110 are provided at mutually different locations in the diametric direction, the passage holes 84 formed in the cap fitting 48 will be closed off by the valve member 110, and the communication window 116 formed in the valve member 110 will be closed off by the cap fitting 48. Through intimate contact of the cap fitting 48 and the valve fitting 112 via the cushion rubber layer 114, the passage holes 84 and the communication window 116 are each blocked off fluid-tightly.

Thus, with the coil (described later) in the non-energized state, the valve housing zone 82 and the pressure receiving chamber 96 will be separated fluid-tightly by the valve member 110 and the cap fitting 48, and the second orifice passage 117 will be placed in the blocked off state. The blocked off state of the second orifice passage 117 refers to a state in which no fluid flow can be produced in the second orifice passage 117.

A coil member 120 is embedded in the partition member 44. The coil member 120 includes a yoke 122, and a coil 124 wound onto the yoke 122. The yoke 122 is formed of ferromagnetic material, and is of generally cylindrical shape integrally composed of a floor plate of annular plate shape, an inside peripheral side wall extending upward from the inside peripheral edge of the floor plate, and an outside peripheral side wall extending upward from the outside peripheral edge of the floor plate. The coil 124 is situated between the inside peripheral side wall and the outside peripheral side wall. The coil member 120 of generally circular cylinder shape is constituted thereby.

In the present embodiment, this coil member 120 is disposed coaxially with the through-passage hole 66, and is embedded in the interior of the partition member body 46 so as to encircle the entire circumference of the through-passage hole 66. In the present embodiment, the coil member 120 is embedded internally during molding of the partition member body 46, for example, by being pre-set in the mold when the partition member body is formed by means such as injection molding or the like.

Also, in the present embodiment, a lead wire 132 connected to the coil 124 is disposed extending through the interior of the partition member body 46, and leading to the outside from the outside peripheral face of the partition member body 46 which lies exposed to the outside axially between the second mounting member 14 and the fastener fitting 90. Furthermore, one end of the lead wire 132 is connected to the coil 124, while the other end is connected to a power unit 134. Thus, the coil 124 can be energized through the lead wire 132 from the power unit 134.

When the coil 124 is energized from the power unit 134, the magnetic force generated thereby produces attracting force which acts on the valve fitting 112 formed of magnetic material. Due to the action of the magnetic attracting force, the valve member 110 will be attracted and displaced towards the partition member body 46 side in opposition to the urging force of the coil spring 118. The valve member 110 will thereby be moved axially downward away from the cap fitting 48, and thus the passage holes 84 and the communication window 116 will be placed in communication, placing the valve housing zone 82 in communication with the pressure receiving chamber 96 through the passage holes 84 and the communication window 116. Thus, with the coil 124 in the energized state, the second orifice passage 117 will assume the communicating state. Accordingly, with the coil 124 in the energized state, the pressure receiving chamber 96 and the equilibrium chamber 98 will communicate with each other through the second orifice passage 117.

In short, in the present embodiment, by controlling the supply of power to the coil 124, the valve member 110 can be induced to undergo displacement in the direction towards and the direction away from the cap fitting 48, making it possible to switch the second orifice passage 117 between the cutoff state and the communicating state.

The communicating state of the second orifice passage 117 refers to a state in which fluid flow can take place through the second orifice passage 117. Specifically, in the present embodiment, the middle chamber 80, with which the lower end of the second orifice passage 117 communicates, allows change in volume due to the fact that a portion of the wall thereof is constituted by the elastically deformable movable rubber film 76. Consequently, when vibration of the tuning frequency of the second orifice passage 117 is input, the valve housing zone 82 will be placed in communication with the pressure receiving chamber 96 through the opening operation of the valve member 110, whereupon fluid flow will take place through the second orifice passage 117. Thus, with the valve member 110 in the opened state when the coil 124 is energized, the second orifice passage 117 will be placed in the communicating state. In the present embodiment, this communicating state of the second orifice passage 117 refers to one in which the pressure receiving chamber 96 and the equilibrium chamber 98 are substantially in communication with one another through the second orifice passage 117, utilizing transmission of liquid pressure by elastic deformation of the movable rubber film 76.

In other words, in the present embodiment, the passage holes 84, the communication window 116, the upper recess 60, the through-passage hole 66, the lower recess 62, and the center hole 72 constitute a communication passage connecting the pressure receiving chamber 96 with the equilibrium chamber 98. The movable rubber film 76 is disposed on this communication passage and restricts free flow of fluid. Also, the second orifice passage 117 is situated on this communication passage; and the valve member 110 for switching the passage holes 84 and the communication window 116 between the communication state and the blocked state is also disposed thereon. In the present embodiment, the valve member 110 is arranged to the pressure receiving chamber 96 side of the through-passage hole 66, while the movable rubber film 76 is arranged to the equilibrium chamber 98 side thereof. With the passage holes 84 and the communication window 116 placed in the communicating state through opening operation of the valve member 110, pressure in the pressure receiving chamber 96 will be exerted on the movable rubber film 76 through the second orifice passage 117. On the other hand, with the passage holes 84 and the communication window 116 placed in the cutoff state through closing operation of the valve member 110, pressure in the pressure receiving chamber 96 will be not be exerted on either the second orifice passage 117 or the movable rubber film 76.

As will be apparent from the above discussion, in the present embodiment, a valve member is constituted so as to include the valve member 110, the coil spring 118, and the coil 124. The valve body is induced to close on the basis of elastic force exerted on the valve member 110 by the coil spring 118; and the valve body is induced to open on the basis of attraction force exerted on the valve fitting 112 by energizing of the coil 124.

In the automotive engine mount 10 pertaining to the present embodiment, when vibration is input across the first mounting member 12 and the second mounting member 14, fluid will be induced to flow through the orifice passages 106, 117 on the basis of pressure fluctuations produced in the pressure receiving chamber 96, and vibration damping action will be produced on the basis of the flow behavior of the fluid.

Specifically, in the present embodiment, during normal driving of the automobile, the external power unit 134 will not energize the coil 124, and thus the valve member 110 will be closed by the urging force of the coil spring 118, blocking off the second orifice passage 117. Therefore, fluid flow through the first orifice passage 106 will be produced effectively on the basis of the relative pressure differential between the pressure receiving chamber 96 and the equilibrium chamber 98; and excellent vibration damping action will be produced on the basis of the flow behavior, such as the resonance behavior, of fluid induced to flow between the pressure receiving chamber 96 and the equilibrium chamber 98.

In particular, in the present embodiment, the resonance frequency of fluid induced to flow through the first orifice passage 106 with the valve member 110 in the closed state is tuned to a low frequency band on the order of ten-plus Hz, so that vibration damping action based on flow behavior of fluid induced to flow through the first orifice passage 106 is effectively exhibited against vibration corresponding to engine shake of the automobile.

On the other hand, when the automobile is at a stop, the coil 124 will be supplied with power from the outside by the power unit 134, and due to the magnetic field generated by the coil 124 the valve fitting 112 which is fabricated of ferromagnetic material will be attracted and displaced axially downward, i.e., towards the partition member body 46 side, through the action of the magnetic force. Then, as shown in FIG. 2, the valve fitting 112 will separate downwardly in the axial direction away from the cap fitting 48, whereby the passage holes 84 formed in the cap fitting 48 and the communication window 116 formed in the valve member 110 will each be placed in communication, and the second orifice passage 117 will assume the communicating state. The pressure receiving chamber 96 and the equilibrium chamber 98 will thereby be placed in communication with each other through the second orifice passage 117. Thus, excellent vibration damping action will be produced on the basis of the flow behavior, such as the resonance behavior, of fluid induced to flow through the second orifice passage 117.

In particular, in the present embodiment, the resonance frequency of fluid induced to flow through the second orifice passage 117 is tuned to a medium- to high-frequency band on the order of between 15 and 40 Hz, so that vibration damping action based on flow behavior of fluid induced to flow through the second orifice passage 117 is effectively exhibited against vibration corresponding to medium- to high-frequency idling vibration of the automobile. The tuning frequency of the first and second orifice passages 106, 117 can be set through proper adjustment of the ratio of passage length and passage cross sectional area.

Also, in the present embodiment, fluid flow through the second orifice passage 117 due to input of idling vibration of a medium- to high-frequency band is achieved advantageously through resonance behavior of the movable rubber film 76. Specifically, in the present embodiment, by tuning the natural vibration frequency of the movable rubber film 76 to a medium- to high-frequency band corresponding to idling vibration, when medium- to high-frequency idling vibration is input, the movable rubber film 76 will be induced to actively deform elastically through resonance. Thus, flow of fluid through the second orifice passage 117 can be advantageously assured, and vibration-damping action based on flow behavior can be achieved effectively.

When the coil 124 is energized, excellent vibration damping action against low-frequency idling vibration, namely vibration in a low-frequency band, will be exhibited through flow of fluid through the first orifice passage 106. In the present embodiment, with flow of fluid through the first orifice passage 106 with the second orifice passage 117 in the communicating state, a substantial pressure receiving chamber will be constituted by the middle chamber 80 and the valve housing zone 82, in addition to the pressure receiving chamber 96. Consequently, with the second orifice passage 117 in the communicating state, a portion of the wall of the substantial pressure receiving chamber will be constituted by the movable rubber film 76, and the spring hardness of the wall will be lower in comparison to the pressure receiving chamber 96 when the second orifice passage 117 is in the cutoff state. Thus, when the second orifice passage 117 is in the communicating state, the tuning frequency of the first orifice passage 106 will be lower in comparison with that when the second orifice passage 117 is cut off, thereby effecting tuning so as to produce excellent vibration damping action against low-frequency vibration, namely vibration in a low-frequency band on the order of several Hz, on the basis of flow behavior of the fluid.

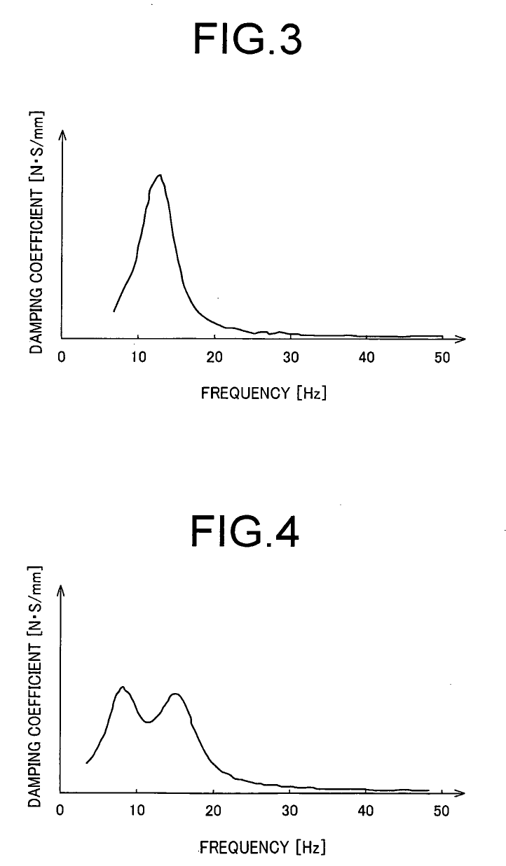

In short, as will be apparent from the characteristic diagrams during driving and when at a stop shown in FIGS. 3 and 4, in the automotive engine mount 10 pertaining to the present embodiment effective vibration damping action will be achieved against vibration of any of three different frequency bands through controlled switching of the second orifice passage 117 between the communicating state and the cutoff state; and excellent vibration damping action will be achieved both when the automobile is being driven normally and when at a stop. In the present embodiment in particular, changes of the tuning frequency of the first orifice passage 106 may be utilized to achieve excellent vibration damping action against idling vibration which is a problem when the vehicle is at a stop.

Typically, an automobile will be used for longer periods under conditions of driving than under a condition of being at a stop. Accordingly, by energizing the coil 124 at times when the automobile is at stop, as taught in the present embodiment, the duration of energization of the coil 124 can be reduced. Consequently, power consumption can be kept to a minimum, and improved mileage and reduce heat emission by the automobile can be achieved.

Moreover, in the present embodiment, when the coil 124 is not being energized, the valve fitting 112 and the cap fitting 48 will come into cushioned contact via the cushion rubber layer 114. Accordingly, noise and shock can be prevented from occurring during switching from the energized state to the non-energized state.

Also, by embedding the coil 124 in the partition member body 46, contact of the coil 124 with the sealed fluid can be avoided completely. Moreover, in the present embodiment, the lead wire 132 connecting the coil 124 with the external power unit 134 is disposed extending inside the partition member body 46, and leading directly to the outside from the outside peripheral face of the partition member body 46. Accordingly, contact of lead wire 132 with the sealed fluid can be advantageously prevented. Consequently, problems such as electrical leakage that could be caused by energized portions contacting the sealed non-compressible fluid can be advantageously avoided.

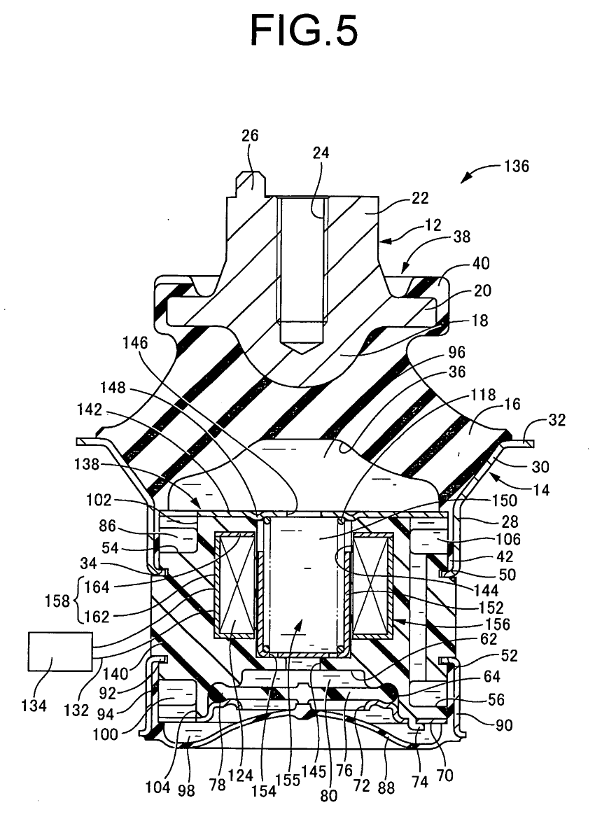

Next, an automotive engine mount 136 is shown in FIG. 5 by way of a second embodiment of the present invention. In the following description, components and parts substantially identical to those of the engine mount 10 shown in the preceding first embodiment are assigned identical symbols in the drawing and are not discussed in any detail.

Specifically, the automotive engine mount 136 pertaining to the present embodiment is furnished with a partition member 138. The partition member 138 is of thick-walled, generally circular block shape overall, and has a partition member body 140 and a cap fitting 142.

The partition member body 140 is a component formed of hard synthetic resin material, and has a thick-walled, generally circular block shape. An upper recess 144 which opens axially upward is formed in the diametrical center section of the partition member body 140. In the present embodiment, the upper recess 144 is a deep circular recess extending in the axial direction with a generally unchanging cross section. A through-passage hole 145 which serves as a communication hole in the present embodiment is formed in the diametrical center section of the partition member body 140, with the upper recess 144 and the lower recess 62 communicating with each other through the through-passage hole 145.

The cap fitting 142 is fabricated of iron, aluminum alloy, or other metal material, and has a thin, generally disk shape. Its diametrical center portion is perforated by a passage hole 146 formed in the thickness direction. This passage hole 146 is a circular hole formed in the diametrical center portion of the cap fitting 142, and perforates the cap fitting 142 in its thickness direction. A positioning convex portion 148 is provided spaced apart by a prescribed distance to the outside peripheral side of the passage hole 146, and extends continuously about the entire circumference.

The partition member 138 is constituted by juxtaposing the cap fitting 142 against the partition member body 140 from above. With the partition member body 140 and the cap fitting 142 in the assembled state, the opening of the upper recess 144 formed in the partition member body 140 is covered by the cap fitting 142, and the upper recess 144 is utilized to form a valve housing zone 150. In the present embodiment, the positioning convex portion 148 formed on the cap fitting 142 is mated with a recess formed in the partition member body 140 at the rim of the opening of the upper recess 144, affording ease of positioning in the diametric direction.

Here, a valve fitting 152 provided as a valve body is housed within the valve housing zone 150. The valve fitting 152 is a ferromagnetic body formed of magnetic material such as iron, and has a generally bottomed circular cylinder shape overall. The outside diameter of the valve fitting 152 is slightly smaller than the inside diameter of the valve housing zone 150, providing a gap between the outside peripheral face of the valve fitting 152 and the inside face of the side wall of the valve housing zone 150.

Communication windows 154 are formed in the floor of the valve fitting 152 constituting the plate shaped portion in the present embodiment. A plurality of the communication windows 154 are disposed spaced apart by prescribed intervals in the circumferential direction and passing through the floor of the valve fitting 152 in the thickness direction, i.e. the axial direction. Furthermore, with the valve fitting 152 installed in the valve housing zone 150, the communication windows 154 formed in the valve fitting 152 will be situated at different locations in the diametric direction from the through-passage hole 145 which is formed in the partition member body 140. In the present embodiment, the opening of the through-passage hole 145 is formed in the approximate diametrical center, while the plurality of communication windows 154 are situated spaced apart to the outside peripheral side so as to encircle the through-passage hole 145.

In the present embodiment, the pressure receiving chamber 96 and the middle chamber 80 communicate with each other through the passage hole 146, the valve housing zone 150, the communication windows 154, and the through-passage hole 145. The middle chamber 80 is substantially in communication with the equilibrium chamber 98 through transmission of liquid pressure by elastic deformation of the movable rubber film 76. Thus, the second orifice passage 155 in the present embodiment is constituted by the passage hole 146, the valve housing zone 150, the communication windows 154, and the through-passage hole 145 which are formed axially between the pressure receiving chamber 96 and the middle chamber 80.

In the present embodiment, the cross sectional area of the passage hole 146, the total cross sectional area of the communication windows 154, and the cross sectional area of the through-passage hole 145 are approximately equal; by adjusting the ratio of cross sectional area of the passage hole 146, the communication windows 154, and the through-passage hole 145 to the passage length of the second orifice passage 155, the tuning frequency of the second orifice passage 155 is tuned to a higher frequency band than the tuning frequency of the first orifice passage 106.

A coil spring 118 is installed in the valve fitting 152 of bottomed circular cylinder shape. In the present embodiment, the coil spring 118 is inserted on the inside peripheral side of the valve fitting 152, with the coil spring 118 pre-compressed by a prescribed amount and interposed between axially opposed faces of the floor of the valve fitting 152 and the cap fitting 142. In the present embodiment, the upper end of the coil spring 118 fits within the inside peripheral side of the convex portion 148 provided on the cap fitting 142, and is positioned in the diametric direction thereby.

By installing the coil spring 118 between the valve fitting 152 and the cap fitting 142 in this way, with the coil (discussed later) in the non-energized state, the valve fitting 152 will be urged axially downward by the elastic force of the coil spring 118, pushing the floor of the valve fitting 152 from above against the lower side wall portion of the valve housing zone 150. The floor of the valve fitting 152 will then be pushed against the floor of the valve housing zone 150, whereby the through-passage hole 145 will be blocked off by the valve fitting 152, and the communication windows 154 will be blocked off by the outside peripheral section of the floor of the valve housing zone 150. Thus, with the coil in the non-energized state, the second orifice passage 155 will be placed in the cutoff state.

A coil member 156 is embedded in the partition member 138. The coil member 156 includes a yoke 158 and a coil 124. The yoke 158 is formed of magnetic material, and is constructed of an upper yoke fitting 164 of annular plate shape attached from above to a lower yoke fitting 162 of generally bottomed circular cylinder shape provided with a floor of annular plate shape. The coil member 156 is constituted by installing the coil 124 between the opposed faces of the floor of the lower yoke fitting 162 and the upper yoke fitting 164.

The coil member 156 of the structure described above is installed in the interior of the partition member body 140. Specifically, the coil member 156 is installed encircling the outside peripheral side of the valve housing zone 150. In the present embodiment, as in the preceding first embodiment, the coil member 156 is embedded during the process of molding the partition member body 140.

Here, the yoke 158 is magnetized through the action of a magnetic field generated in the coil 124 when power is supplied to the coil 124 from an external power unit 134. Then, the upper end of the valve fitting 152, which is fabricated of magnetic material, is attracted by the magnetized upper yoke fitting 164, thereby attracting and displacing the valve fitting 152 axially upward. Through displacement of the valve fitting 152 in this way, the floor of the valve fitting 152 will move upwardly away from the floor of the valve housing zone 150, placing the communication windows 154 formed in the valve fitting 152 and the through-passage hole 145 formed in the partition member body 140 in the communicating state. Thus, with the coil 124 in the energized state, the second orifice passage 155 will be placed in the communicating state. Consequently, with the coil 124 in the energized state, the pressure receiving chamber 96 and the equilibrium chamber 98 will communicate with each other through the second orifice passage 155.

In other words, in the present embodiment, the passage hole 146, the upper recess 144, the communication windows 154, the through-passage hole 145, the lower recess 62, and the center hole 72 constitute a communication passage connecting the pressure receiving chamber 96 with the equilibrium chamber 98. The movable rubber film 76 is disposed on this communication passage and restricts free flow of fluid. Also, the second orifice passage 155 is situated on this communication passage; and the valve fitting 152 for switching the communication windows 154 and the through-passage hole 145 between the communication state and the blocked state is also disposed thereon. In the present embodiment, the valve fitting 152 is arranged to the pressure receiving chamber 96 side of the second orifice passage 155, while the movable rubber film 76 is arranged to the equilibrium chamber 98 side thereof. With the communication windows 154 and the through-passage hole 145 placed in the communicating state through opening operation of the valve fitting 152, pressure in the pressure receiving chamber 96 will be exerted on the movable rubber film 76 through the second orifice passage 155; whereas with the communication windows 154 and the through-passage hole 145 placed in the cutoff state through closing operation of the valve fitting 152, pressure in the pressure receiving chamber 96 will be not be exerted on the movable rubber film 76. As will be apparent from the above discussion, in the present embodiment, a valve member is constituted so as to include the valve fitting 152, the coil spring 118, and the coil 124.

The automotive engine mount 136 having structure in accordance with this embodiment affords effects similar to those of the automotive engine mount 10 shown in the previous first embodiment. Specifically, by controlling energization of the coil 124 and opening or closing the valve fitting 152 according to the driving condition of the vehicle or the like, it is possible to achieve effective vibration damping action against input of engine shake, medium- to high-frequency idling vibration, or low-frequency idling vibration.

Moreover, in the present embodiment as well, since the coil 124 is energized at times that the vehicle is at a stop, energization time can be relatively short, and advantages such as reduced power consumption and improved mileage may be advantageously achieved.

Also, in the present embodiment, the valve fitting 152 is pushed against the wall of the valve housing zone 150 on the equilibrium chamber 98 side thereof, thereby cutting off the second orifice passage 155. Moreover, the urging force exerted on the valve fitting 152 by the coil spring 118 has been adjusted appropriately, and in the event that a high level of negative pressure has been produced in the pressure receiving chamber 96 by input of large-amplitude vibration, the valve fitting 152 will be induced by the action of the negative pressure to move away from the floor of the valve housing zone 150 in opposition to the urging force of the coil spring 118. Thus, in the event that excessive negative pressure has been produced in the pressure receiving chamber 96 by input of high impact load, the second orifice passage 155 will assume the communicating state so that the negative pressure in the pressure receiving chamber 96 can be dissipated rapidly by flow of fluid through the second orifice passage 155. Consequently, the occurrence of noise and vibration due to cavitation attributed to negative pressure within the pressure receiving chamber 96 can be advantageously prevented.

While the present invention has been shown hereinabove through certain preferred embodiments, these are merely exemplary and should not be construed as limiting the invention in any way to the specific disclosure of the embodiments herein.

For example, the valve body should not be construed as being limited to the structures taught in the first and second embodiments above. Specifically, the communication window 116 formed in the valve fitting 112 is not essential. It would be acceptable to instead employ as the valve body a valve fitting capable of blocking off the passage holes 84 and having disk shape sufficiently small in diameter relative to the valve housing zone 82, and to place the passage holes 84 in the communicating state by energizing the coil 124, thereby inducing flow of fluid through a gap formed between the valve fitting and the peripheral wall of the valve housing zone 82, and placing the second orifice passage 117 in the communicating state.

Also, whereas in the first and second embodiments hereinabove the coil 124 was embedded in a partition member 44, 138, the coil 124 need not necessarily be embedded in the partition member 44, 138, and may instead be installed in the interior thereof. Specifically, a recess for installation of the coil 124 may be formed in the partition member, and the coil 124 then installed in the recess, also providing a cap member to cover fluid-tightly the opening of the recess, to thereby install the coil 124 in the interior of the partition member.

Also, whereas in the first and second embodiments hereinabove, a yoke 122, 158 formed of ferromagnetic material was positioned about the coil 124, a yoke is not always necessary, and it would be acceptable, for example, to attach the coil 124 to a bobbin formed of nonmagnetic synthetic resin material, and installed in this state in the partition member.

Moreover, the structures of the first and second mounting members 12, 14, of the partition member 44 (138), and so on should not be construed as being limited to those taught in the first and second embodiments hereinabove. For example, the partition member 44 (138) need not always be disposed with part of its outside peripheral face exposed to the outside, and could instead by attached to the second mounting member 14 by being press-fit in the inside peripheral side of the cylindrical second mounting member 14.

In the first and second embodiments, the movable rubber film 76 is disposed to the equilibrium chamber 98 side of the through-passage hole 66 (145); however, the movable rubber film 76 could instead be disposed to the pressure receiving chamber 96 side of the through-passage hole 66 (145).

It is also to be understood that the present invention may be embodied with various changes, modifications and improvements which may occur to those skilled in the art, without departing from the spirit and scope of the invention.

What is claimed is:

1. A fluid filled type engine mount comprising:
a first mounting member fixable to one of a power unit and a vehicle body;
a second mounting member mounted on another of the power unit and the vehicle body;
a main rubber elastic body elastically connecting the first mounting member and the second mounting member;
a partition member supported by the second mounting member;
a pressure receiving chamber whose wall is partially constituted by the main rubber elastic body and having a non-compressible fluid filled therein;
an equilibrium chamber whose wall is partially constituted by a readily deforming, flexible film and having the non-compressible fluid filled therein, the chambers being formed respectively to either side of the partition member;
a first orifice passage and a second orifice passage respectively connecting the pressure receiving chamber and the equilibrium chamber to each other, with the second orifice passage being tuned to a frequency band corresponding to idling vibration which is a higher frequency band than the first orifice passage; and
a valve member actuated by energization from an outside so that the second orifice passage is switchable between a communicating state and a cutoff state by the valve member;
wherein a movable film is disposed in the partition member so that the second orifice passage connects the pressure receiving chamber and the equilibrium chamber via the movable film;
wherein the valve member includes: a valve body formed of ferromagnetic material; an urging member for exerting urging force on the valve body so that the second orifice passage is placed in the cutoff state by the valve body when the urging member is in an initial state; and a coil disposed in an interior of the partition member, and
wherein the coil is energized to generate a magnetic field by which the valve body is displaced in order to place the second orifice passage in the communicating state.

2. The fluid filled type engine mount according to claim 1, wherein the partition member is furnished with a valve housing zone situated on a fluid passage passing through the second orifice passage and having the valve body disposed housed therein; with the urging member in the initial state, a communication hole used for fluid flow which opens into the valve housing zone is blocked off by the valve body thereby placing the second orifice passage in the cutoff state; and by energizing the coil the valve body is moved apart from a wall of the valve housing zone thereby opening the communication hole and placing the second orifice passage in the communicating state.

3. The fluid filled type engine mount according to claim 2, wherein the valve body includes a plate-shaped portion having a communication window formed at a location that, with the valve body disposed housed within the valve housing zone, is situated away from a formation location of the communication hole; with the urging member in the initial state, the plate-shaped portion is juxtaposed against the wall of the valve housing zone where the communication hole is formed, blocking off the communication hole and the communication window and thereby placing the second orifice passage in the cutoff state; and by energizing the coil the plate-shaped portion is displaced through magnetic attraction moving the plate-shaped portion away from the wall of the valve housing zone so as to open up the communication hole and the communication window, thereby placing the second orifice passage in the communicating state.

4. The fluid filled type engine mount according to claim 3, wherein the communication hole and the communication window are disposed at mutually different locations in a diametric direction.

5. The fluid filled type engine mount according to claim 1, wherein the urging member comprises a coil spring that is interposed between the valve body and the partition member.

6. The fluid filled type engine mount according to claim 1, wherein the valve body undergoes displacement in opposition to the urging force of the urging member upon generation of a high level of negative pressure produced in the pressure receiving chamber to thereby place the second orifice passage in the communicating state.

7. The fluid filled type engine mount according to claim 2, wherein the partition member has a generally circular cylindrical shape overall, and the second orifice passage extends in an axial direction through a diametrical center section of the partition member with an axially upper end opens to the pressure receiving chamber and an axially lower end opens to the equilibrium chamber via the movable film disposed on an axially lower end portion of the partition member so as to be movable due to a fluid pressure difference applied on one face opposed to the axially lower end of the second orifice passage and another face opposed to the equilibrium chamber, and the coil is disposed about the second orifice passage, while the valve housing zone is disposed near the axially upper end of the second orifice passage.
